(19) United States
(12) Patent Application Publication
(10) Pub. No.: US 2025/0391006 A1
(43) Pub. Date: Dec. 25, 2025

(54) IMPLEMENTING FEATURES GENERATED USING DISCRETE EFFECTIVE MEDIUM REFRACTIVE ANALYSIS OF PATTERNED SUBSTRATES

(71) Applicant: Applied Materials, Inc., Santa Clara, CA (US)

(72) Inventors: Imaan Seraphine Islam Rahim, Campbell, CA (US); Thomas Ho Fai Li, Santa Clara, CA (US); Varoujan Chakarian, San Jose, CA (US); Zhaozhao Zhu, Milpitas, CA (US); Blake W. Erickson, Gilroy, CA (US)

(21) Appl. No.: 18/751,733

(22) Filed: Jun. 24, 2024

(51) Int. Cl. G06T 7/00; G01N 21/88; G01N 21/95; G06T 7/60

(52) U.S. Cl. CPC G06T 7/0004; G01N 21/8851; G01N 21/9501; G06T 7/60; G01N 2021/8887; G06T 2207/20081; G06T 2207/30148

(57) ABSTRACT

A method includes obtaining, by at least one processing device, spectral data associated with a patterned substrate, generating, by the at least one processing device from the spectral data, a set of features using discrete effective medium refractive analysis (DEMRA) of the patterned substrate, and processing, by the at least one processing device, the set of features using a machine learning model to predict at least one characteristic of the patterned substrate from the set of features. The set of features includes a set of fitted parameters corresponding to an empirical model that relates at least one effective index of refraction associated with the patterned substrate to a wavelength of light incident on the patterned substrate.

### TECHNICAL FIELD

Embodiments of the present disclosure relate generally to electronic device fabrication, and, more particularly, relate to using discrete effective medium refractive analysis (DEMRA) of patterned substrates and one or more trained machine learning models to determine properties about the patterned substrates.

### BACKGROUND

Metrology is the science of measuring and analyzing properties of materials. For example, in the context of electronic device fabrication (e.g., semiconductor device fabrication), metrology equipment can be used to measure characteristics or properties of substrates or wafers (e.g., physical and electrical properties). Illustratively, metrology equipment can be used to measure material thicknesses, measure feature sizes, detect material defects that may negatively affect electronic device performance (e.g., surface particles or pattern flaws), verify that target characteristics of a device being manufactured are being met, etc.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a method includes obtaining, by at least one processing device, spectral data associated with a patterned substrate, generating, by the at least one processing device from the spectral data, a set of features using discrete effective medium refractive analysis (DEMRA) of the patterned substrate, and processing, by the at least one processing device, the set of features using a machine learning model to predict at least one characteristic of the patterned substrate from the set of features. The set of features includes a set of fitted parameters corresponding to an empirical model that relates at least one effective index of refraction associated with the patterned substrate to a wavelength of light incident on the patterned substrate.

In another aspect of the disclosure, a system includes a memory and a processing device, operatively coupled to the memory, to obtain spectral data associated with a patterned substrate, generate, from the spectral data, a set of features using discrete effective medium refractive analysis (DEMRA) of the patterned substrate, and process the set of features using a machine learning model to predict at least one characteristic of the patterned substrate from the set of features. The set of features includes a set of fitted parameters corresponding to an empirical model that relates at least one effective index of refraction associated with the patterned substrate to a wavelength of light incident on the patterned substrate.

In another aspect of the disclosure, a system includes a memory and a processing device, operatively coupled to the memory, to obtain spectral data associated with a patterned substrate, generate, from the spectral data, a set of features using discrete effective medium refractive analysis (DEMRA) of the patterned substrate, and train, using the set of features, a machine learning model to predict at least one characteristic of the patterned substrate. The set of features includes a set of fitted parameters corresponding to an empirical model that relates at least one effective index of refraction associated with the patterned substrate to a wavelength of light incident on the patterned substrate.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 depicts an illustrative computer system architecture, according to some embodiments of the present disclosure.

FIG. 2 is a top schematic view of an example manufacturing system, according to some embodiments of the present disclosure.

FIG. 3 is a cross-sectional schematic side view of a substrate measurement system, according to some embodiments of the present disclosure.

FIG. 4 is a block diagram of an example system for implementing features generated using discrete effective medium refractive analysis (DEMRA) of patterned substrates, according to some embodiments of the present disclosure.

FIG. 5 is a diagram of an example of using discrete effective medium refractive analysis (DEMRA) to generate a set of features of a patterned substrate, according to some embodiments of the present disclosure.

FIGS. 6A-6B are flowcharts of example methods for implementing features generated using discrete effective medium refractive analysis (DEMRA) of patterned substrates, according to some embodiments of the present disclosure.

FIG. 7 depicts a block diagram of an illustrative computer system operating in accordance with one or more aspects of the present disclosure.

### DETAILED DESCRIPTION

Embodiments described herein relate to processing metrology data (e.g., reflectance data of a surface of a processed patterned substrate) using discrete effective medium refractive analysis (DEMRA) to generate features relating to the patterned substrate, and processing the features using a trained machine learning model to determine characteristics of the patterned substrate, such as critical dimensions (CDs). Examples of characteristics (e.g., CDs) include but are not limited to line width and depth, hole diameter, individual film thicknesses, and other features which can be used to quantitatively describe the structures of the patterned substrate. A patterned substrate is a substrate that has been patterned with features such as trenches, lines, structures, and so on. This is in contrast to a blanket substrate, which is a substrate (e.g., wafer) that has not been patterned. At least one characteristic of a patterned substrate can be determined from optically measured spectra data (“optical spectra data”) using non-machine learning (ML) based techniques or ML based techniques.

Non-ML based techniques of determining a characteristic of a patterned substrate from optical spectra data, such as rigorous coupled-waved analysis (RCWA), can rely on preconceived general models of the structure of the patterned substrate to identify an analytic solution. ML based techniques generally use at least one ML model trained to predict at least one characteristic of a patterned substrate. For example, predicting a characteristic of a patterned substrate can include estimating the characteristic. Some ML-based metrology systems blindly train such ML models using optical spectral data of patterned wafers using naïve (e.g., out-of-the-box) feature transformation methods (e.g., principal component analysis (PCA) or the like). This can contribute to poor model performance, such as on limited (e.g., smaller) data sets.

Embodiments described herein can overcome these and other drawbacks of other measurement techniques by generating feature information about a patterned substrate using DEMRA. A patterned substrate can be formed from a heterogeneous composition of different materials. Analyzing the light propagation through such patterned substrates can be complex, and potentially computationally intractable. DEMRA can be used to simplify the problem by representing a patterned substrate as a discretized model including a stack of multiple layers of a stack (e.g., blanket substrate layers corresponding to thin films or sheets of material), and using more efficient computational techniques to analyze how incident light propagates through the patterned substrate. Each layer of the stack can have an incremental thickness and a respective “effective” index of refraction. An effective index of refraction of a layer is a uniform index of refraction that represents the average way light behaves within the layer. For example, the wavelength of light incident on a surface of a patterned substrate (e.g., vacuum wavelength of light) can exceed the scale of features in the patterned substrate. Thus, an etched pattern in a patterned substrate may not behave like an aperture for the incident light. Instead, the etched pattern can act as a variation in the effective index of refraction along the vertical direction (“depth”). That is, the effective index of refraction is a function of depth. The effective index of refraction function can be informed by the pattern etched (and thus the amount of material removed) at a given depth.

Embodiments described herein can obtain spectral data associated with a patterned substrate, generate a set of features from the spectral data using DEMRA, and use the set of features to train a machine model to predict at least one characteristic of the patterned substrate, or to use a machine learning model trained to predict the at least one characteristic of the patterned substrate from the set of features. For example, predicting the at least one characteristic can include estimating the at least one characteristic.

More specifically, DEMRA can be used to determine a set of fitting parameters of an empirical model that relates the effective index of refraction n to the vacuum wavelength of incident light λ. The set of fitting parameters can be unique to the material of the patterned substrate. Each fitting parameter of a set of fitting parameters is a respective constant value. There are numerous empirical models that can be used to relate the effective index of refraction n to λ for a patterned substrate in accordance with embodiments described herein.

One example of such an empirical model is the Cauchy dispersion model. For example, the Cauchy dispersion model may be used for patterned substrates formed from transparent materials with no absorption in the visible range and having a monotonically decreasing index of refraction. Examples of materials that can be modeled with the Cauchy dispersion model include silicon dioxide, silicon nitride, titanium oxide, etc.

Another example of such an empirical model is the Lorentz model, which is based on the classical theory of light-matter interaction. The Lorentz model can have a single oscillator or can be extended to multiple oscillators for different materials. The Lorentz model can have limitations that make it generally unsuitable for real absorbing materials. The oscillator models of the Lorentz model can be used for insulators such as aluminum oxide, calcium fluoride, indium-tin-oxide (ITO), magnesium fluoride, etc.

Another example of such an empirical model is the Tauc-Lorentz model. For example, the Tacu-Lorentz model may be used for patterned substrates formed from amorphous materials with absorption in the visible range, such as absorbing dielectrics, semiconductors, polymers, etc. Examples of such amorphous materials include amorphous carbon, gallium nitride, polysilicon, etc.

Another example of such an empirical model is the Forouhi-Bloomer model, which is based on the quantum-mechanical theory of absorption. For example, the Forouhi-Bloomer model may be used for patterned substrates formed from amorphous semiconductor materials and/or amorphous dielectric materials. Examples of such amorphous semiconductor materials and amorphous dielectric materials include aluminum nitride, amorphous carbon, amorphous silicon, etc.

Another example of such an empirical model is the Drude model, which is based on the kinetic theory of electrons in a metal (with certain assumptions). The Drude model may be used for patterned substrates formed from metals or heavily doped semiconductors. Examples of such materials include aluminum, cobalt, molybdenum, nickel-iron alloys, titanium, etc.

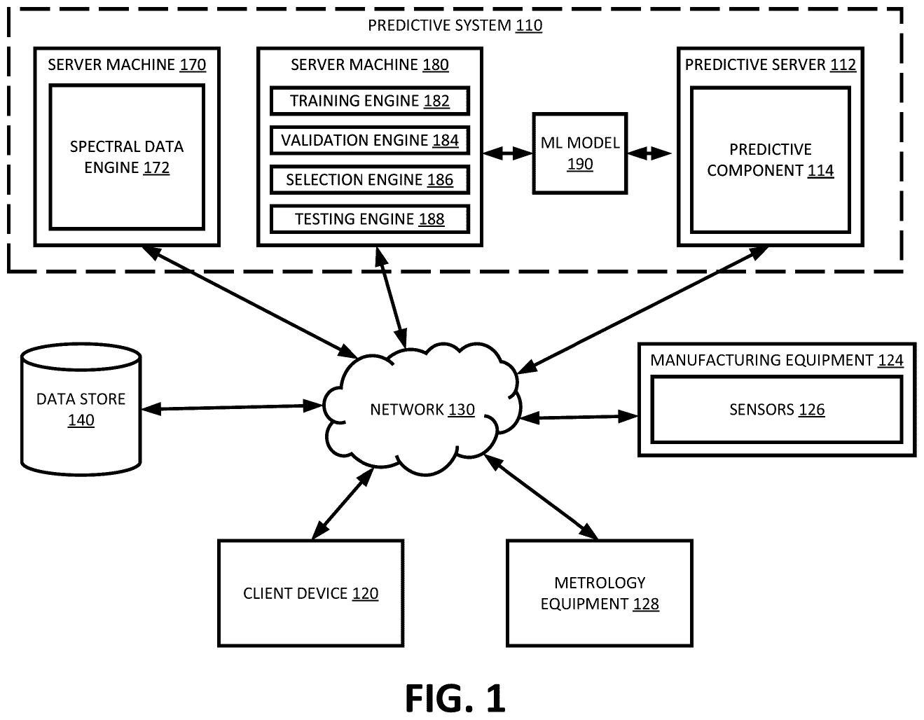

Using DEMRA, values of wavelength (e.g., vacuum wavelength) and reflectance can be used to solve for a set of fitting parameters for the particular empirical model selected to be used for the particular patterned substrate (e.g., Cauchy dispersion model, Lorentz model, Tauc-Lorentz model, Fourhi-Bloomer model, or Drude model). The set of fitting parameters can be used as proxy for physical variation in the effective index of refraction through the patterned substrate. Thus, the set of fitting parameters can be used as a set of features for training an ML model to predict (e.g., estimate) at least one characteristic of the patterned substrate, or for using an ML model trained to predict (e.g., estimate) the at least one characteristic of the patterned substrate from the set of features. Further details regarding implementing features generated using DEMRA of patterned substrates will be described in further detail below with reference to FIGS. 1-7.

Embodiments described herein can provide various technical benefits. For example, by incorporating physical properties of the patterned substrate, embodiments described herein can be used to improve model performance on smaller, more limited data sets by building a feature set tuned to the physical properties of the patterned substrate. Moreover, involving physical properties of the patterned substrate can enable ML models to work across multiple different process recipes, which can reduce or eliminate the practice of training or retraining new ML models for new process recipes.

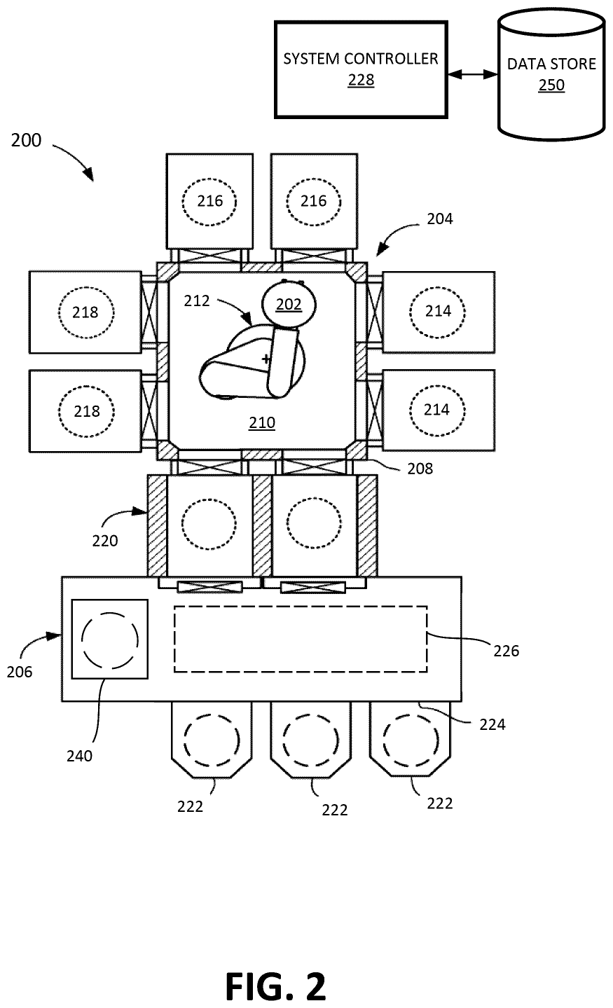

FIG. 1 depicts an illustrative computer system architecture 100, according to aspects of the present disclosure. In some embodiments, computer system architecture 100 may be included as part of a manufacturing system for processing substrates, such as manufacturing system 200 of FIG. 2. Computer system architecture 100 includes a client device 120, manufacturing equipment 124, metrology equipment 128, server machine 130, a predictive server 112 (e.g., to generate predictive data, to provide model adaptation, to use a knowledge base, etc.), and/or a data store 140. The predictive server 112 may be part of a predictive system 110. The predictive system 110 may further include server machines 170 and 180. The manufacturing equipment 124 may include sensors 125 configured to capture data for a substrate being processed at the manufacturing system. In some embodiments, the manufacturing equipment 124 and sensors 126 may be part of a sensor system that includes a sensor server (e.g., field service server (FSS) at a manufacturing facility) and sensor identifier reader (e.g., front opening unified pod (FOUP) radio frequency identification (RFID) reader for sensor system). In some embodiments, metrology equipment 128 may be part of a metrology system that includes a metrology server (e.g., a metrology database, metrology folders, etc.) and metrology identifier reader (e.g., FOUP RFID reader for metrology system).

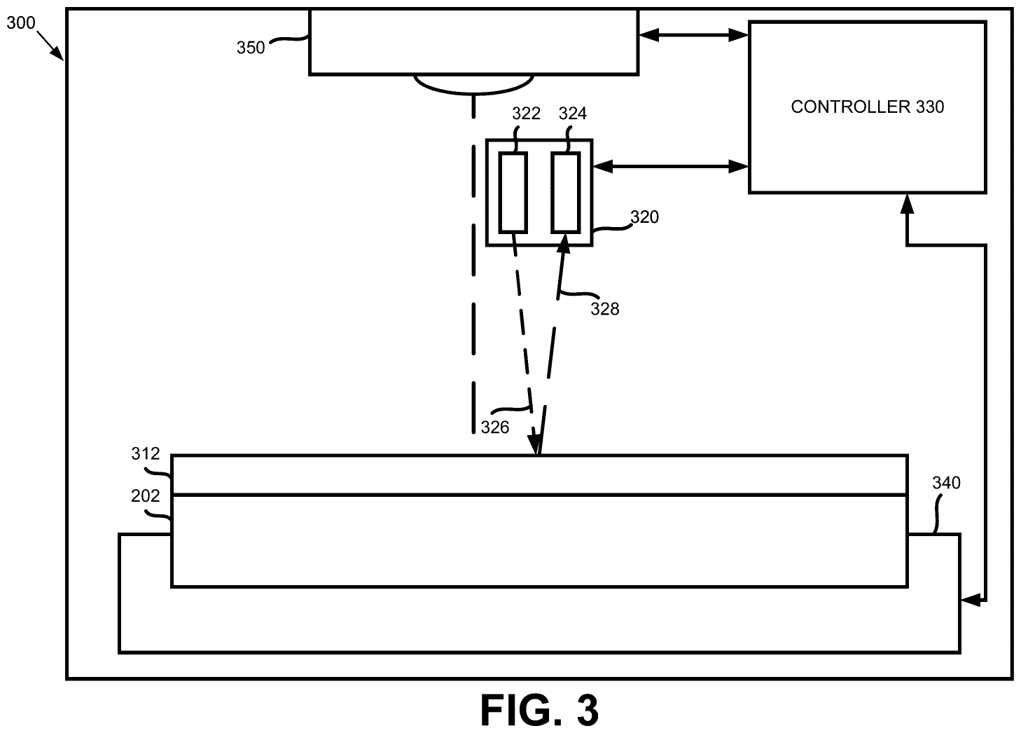

Manufacturing equipment 124 may produce products (e.g., electrical devices) following a recipe or performing runs over a period of time. In some embodiments, manufacturing equipment 124 can include one or more processing chambers that process substrates (e.g., production substrates) according to a process recipe. In other or similar embodiments, the processing chambers of manufacturing equipment 124 can perform an initialization process and/or a maintenance process, which involve performing one or more conditioning operations (e.g., using one or more conditioning substrates) to bring a processing chamber to a condition that is suitable to process production substrates. Manufacturing equipment 124 may include a substrate measurement system that includes one or more sensors 126 configured to generate spectral data and/or positional data for a substrate embedded within the substrate measurement system. Sensors 126 that are configured to generate spectral data (herein referred to as spectra sensing components) may include reflectometry sensors, ellipsometry sensors, thermal spectra sensors, capacitive sensors, and so forth. In some embodiments, spectra sensing components may be included within the substrate measurement system or another portion of the manufacturing system. One or more sensors 126 (e.g., eddy current sensors, etc.) may also be configured to generate non-spectral data for the substrate. Further details regarding manufacturing equipment 124 and the substrate measurement system are provided with respect to FIG. 2 and FIG. 3.

Metrology equipment 128 may provide metrology data associated with substrates (e.g., wafers, etc.) processed by manufacturing equipment 124. For example, the metrology data can include spectral data measured for a substrate (e.g., a profile of the spectra across a surface of the substrate. As described herein, the spectral data can be processed to determine a set of features that can be used by an ML trained to predict at least one characteristic of the substrate from a set of features. For example, the at least one characteristic can include at least one of film property data (e.g., spatial film properties), dimensions (thickness, height, etc.), dielectric constant, dopant concentration, density, defects, or surface profile property data (e.g., an etch rate, an etch rate uniformity, a CD of one or more features included on a surface of the substrate, CD uniformity across the surface of the substrate, an edge placement error, etc.).

The client device 120 my include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. In some embodiments, the metrology data may be received from the client device 120. Client device 120 can display a graphical user interface (GUI), where the GUI enables the user to provide, as input, metrology measurement values for substrates processed at the manufacturing system.

Data store 140 may be a memory (e.g., random access memory), a drive (e.g., a hard drive, a flash drive), a database system, or another type of component or device capable of storing data. Data store 140 may include multiple storage components (e.g., multiple drives or multiple databases) that may span multiple computing devices (e.g., multiple server computers). The data store 140 may store spectral data, non-spectral data, metrology data, and predictive data. Spectral data may include historical spectral data (e.g., spectral data generated for a previous substrate processed at the manufacturing system) and/or current spectral data (spectral data generated for a current substrate being processed at the manufacturing system. Although embodiments of the present disclosure reference spectral data for training a machine learning model, and for inputting into a trained ML model, it should be noted that embodiments of the present disclosure can also include non-spectral data used to train the machine learning model. The data store 140 may also store contextual data associated with a substrate being processed at the manufacturing system (e.g., recipe name, recipe step number, preventive maintenance indicator, operator, etc.).

In some embodiments, data store 140 may be configured to store data that is not accessible to a user of the manufacturing system. For example, spectral data, non-spectral data, and/or positional data obtained for a substrate being processed at the manufacturing system may not be accessible to a user of the manufacturing system. In some embodiments, all data stored at data store 140 may be inaccessible by a user (e.g., an operator) of the manufacturing system. In other or similar embodiments, a portion of data stored at data store 140 may be inaccessible by the user while another portion of data stored at data store 140 may be accessible by the user. In some embodiments, one or more portions of data stored at data store 140 may be encrypted using an encryption mechanism that is unknown to the user (e.g., data is encrypted using a private encryption key). In other or similar embodiments, data store 140 may include multiple data stores where data that is inaccessible to the user is stored in one or more first data stores and data that is accessible to the user is stored in one or more second data stores.

Data store 140 can store data associated with a spectral library in some embodiments. The spectral library can include one or more sets of spectral data collected for a substrate before, during, or after the performance of one or more operations for the substrate at manufacturing equipment 124. Spectral data can be collected for the substrate by a substrate measurement system, as described herein, and/or by other sensors 126 of manufacturing equipment 124, in some embodiments. In an illustrative example, the spectral library can include one or more sets of spectral data collected before, during, or after the performance of a substrate process for a substrate (e.g., a production substrate) at one or more processing chambers of manufacturing equipment. In another illustrative example, the spectral library can include one or more sets of spectral data collected before, during, or after the performance of an initialization process and/or a maintenance process (e.g., a PM process, a CM process, etc.) performed for a processing chamber of manufacturing equipment 124. In some embodiments, the spectral library can include additional data associated with a substrate for which spectral data was collected and/or a process recipe and/or manufacturing equipment 124 used to process such substrate. For example, for a respective set of spectral data collected for a substrate, the spectral library can include an indication of an identifier associated with the substrate, a type associated with the substrate, a process recipe associated with the substrate, one or more operations of the process recipe that were performed for the substrate, an identifier for a processing chamber that processed the substrate (e.g., according to the one or more operations), a type associated with the processing chamber, one or more settings associated with the processing chamber (e.g., before, after, or during performance of the one or more operations), a date and/or time when the process recipe was performed for the substrate, metrology data collected for the substrate after performance of the one or more operations, a condition of the processing chamber before, during, or after performance of the one or more operations, and so forth. In other or similar embodiments, the additional data associated with a substrate can be stored at another region of data store 140 (e.g., separate from the spectral library).

In some embodiments, system 100 can include at least one server machine 170 that includes spectral data engine 172. An engine may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiments, a substrate measurement system that collects spectral data for a substrate can transmit the spectral data to spectral data engine 172 (e.g., via network 130). Spectral data engine 172 can, in some embodiments, generate a mapping between the spectral data collected for a respective substrate and additional data associated with the substrate and/or a process recipe and/or manufacturing equipment 124, as described above. Spectral data engine 172 can store an indication of the mapping at data store 140 (e.g., with the spectral library and/or at another region of data store 140). In some embodiments, spectral data engine 172 can provide spectral data received from a substrate measurement system to predictive component 114 (e.g., via network 130). Predictive component 114 can process the spectral data using DEMRA to generate a set of features, and use a trained ML model 190 to predict at least one characteristic of the substrate from the set of features, as described herein, in some embodiments. It should be noted that although FIG. 1 illustrates that spectral data engine 172 resides at server machine 130, spectral data engine 172 can reside at any computing system or component of system 100. For example, one or more portions of spectral data engine 172 can be included in predictive component 114, in some embodiments. In another example, one or more portions of spectral data engine 172 can included with a system controller for the manufacturing system of system 100 (e.g., system controller 228 of FIG. 2). In yet another example, one or more portions of spectral data engine 172 can reside at client device 120.

In some embodiments, predictive system 110 includes server machine 170 and server machine 180. Spectra data engine 172 can generate training data sets (e.g., a set of data inputs and a set of target outputs) to train, validate, and/or test ML model 190. In some embodiments, spectral data engine 172 may partition the training data into a training set, a validating set, and a testing set. In some embodiments, predictive system 110 generates multiple sets of training data. For example, a first set of training data may correspond to a first type of spectral data (e.g., reflectometry spectral data) and a second set of training data may correspond to a second type of spectral data (ellipsometry spectral data). In some embodiments, spectral data engine 172 can generate training data based on data of the spectral library, in accordance with embodiments described herein.

Server machine 180 may include a training engine 182, a validation engine 184, a selection engine 185, and/or a testing engine 186. Training engine 182 may be capable of training ML model 190. ML model 190 can be trained by training engine 182 using the training data that includes training inputs and corresponding target outputs (correct answers for respective training inputs). In some embodiments, the training inputs may include features (e.g., feature vectors) generated from spectral data for historical substrates using DEMRA in embodiments. Training engine 182 may find patterns in the training data that map the training input to the target output (the answer to be predicted) and provide the ML model 190 that captures these patterns. ML model 190 may use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), etc.

Validation engine 184 can validate trained ML model 190 using a corresponding set of features of a validation set from training set generator 172. Validation engine 184 can determine an accuracy of multiple ML models based on the corresponding sets of features of the validation set. Validation engine 184 can discard ML models that have an accuracy that does not meet a threshold accuracy. In some embodiments, selection engine 185 can select trained ML model 190 as a ML model having an accuracy that meets a threshold accuracy. In some embodiments, the selection engine 185 can select trained ML model 190 as a ML model that has the highest accuracy among the multiple ML models.

Testing engine 186 can test ML models using a corresponding set of features of a testing set (e.g., generated by spectra data engine 172). For example, a ML model that was trained using a set of features may be tested using a testing set including the set of features. Testing engine 186 may identify ML model 190 as having the highest accuracy of all trained ML models based on the testing sets.

In additional or alternative embodiments, ML model 190 can be trained to predict, based on a set of features generated from given spectral data, a respective process recipe associated with the substrate and one or more operations of the respective process recipe that have already been performed for the substrate. In additional or alternative embodiments, ML model 190 can be trained to predict, based on a set of features generated from given spectral data for a respective substrate (e.g., a conditioning substrate), a condition of a respective processing chamber of the manufacturing system that processed the substrate. Further details regarding training and using ML model 190 are provided herein.

The client device 120, manufacturing equipment 124, sensors 126, metrology equipment 128, predictive server 112, server machine(s) 130, data store 140, server machine 170, and server machine 180 may be coupled to each other via a network 130. In some embodiments, network 130 is a public network that provides client device 120 with access to predictive server 112, data store 140, and other publicly available computing devices. In some embodiments, network 130 is a private network that provides client device 120 access to manufacturing equipment 124, metrology equipment 128, data store 140, and other privately available computing devices. Network 130 may include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

It should be noted that in some other implementations, the functions of server machines 130, 170 and 180, as well as predictive server 112, may be provided by a fewer number of machines. For example, in some embodiments, server machines 130, 170 and 180 may be integrated into a single machine, while in some other or similar embodiments, server machines 130, 170 and 180, as well as predictive server 112, may be integrated into a single machine.

In general, functions described in one implementation as being performed by server machine 130, server machine 170, server machine 180, and/or predictive server 112 can also be performed on client device 120. In addition, the functionality attributed to a particular component can be performed by different or multiple components operating together.

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

FIG. 2 is a top schematic view of an example manufacturing system 200, according to aspects of the present disclosure. Manufacturing system 200 may perform one or more processes on a substrate 202. Substrate 202 may be any suitably rigid, fixed-dimension, planar article, such as, e.g., a silicon-containing disc or wafer, a patterned wafer, a glass plate, or the like, suitable for fabricating electronic devices or circuit components thereon. In some embodiments, substrate 202 can be a production substrate (e.g., a substrate used for production of a product, such as an electronic device), a conditioning substrate (e.g., a substrate used during performance of one or more conditioning operations, such as an initialization process and/or a maintenance process), and/or any other type of substrate.

Manufacturing system 200 may include a process tool 204 and a factory interface 206 coupled to process tool 204. Process tool 204 may include a housing 208 having a transfer chamber 210 therein. Transfer chamber 210 may include one or more processing chambers (also referred to as processing chambers) 214, 216, 218 disposed therearound and coupled thereto. Processing chambers 214, 216, 218 may be coupled to transfer chamber 210 through respective ports, such as slit valves or the like. Transfer chamber 210 may also include a transfer chamber robot 212 configured to transfer substrate 202 between processing chambers 214, 216, 218, load lock 220, etc. Transfer chamber robot 212 may include one or multiple arms where each arm includes one or more end effectors at the end of each arm. The end effector may be configured to handle particular objects, such as wafers.

Processing chambers 214, 216, 218 may be adapted to carry out any number of processes on substrates 202. A same or different substrate process may take place in each processing chamber 214, 216, 218. In some embodiments, processing chamber 214, 216, 218 can perform a substrate process for one or more substrates 202. A substrate process may include atomic layer deposition (ALD), physical vapor deposition (PVD), chemical vapor deposition (CVD), etching, annealing, curing, pre-cleaning, metal or metal oxide removal, or the like. In some embodiments, a substrate process may include a combination of two or more of atomic layer deposition (ALD), physical vapor deposition (PVD), chemical vapor deposition (CVD), etching, annealing, curing, pre-cleaning, metal or metal oxide removal, or the like. Other processes may be carried out on substrates therein. For example, an initialization process can be performed at one or more of processing chambers 214, 216, 218 to prepare processing chambers 214, 216, 218 for a substrate process. In another example, a maintenance process (e.g., a PM process, a CM process, etc.) can be performed to mitigate and/or correct wear or damage to components and/or an interior of processing chambers 214, 216, 218. Processing chambers 214, 216, 218 may each include one or more sensors configured to capture data for substrate 202 and/or an environment within processing chamber 214, 216, 218, before, after, or during a substrate process. In some embodiments, the one or more sensors may be configured to capture spectral data and/or non-spectral data for a portion of substrate 202.

A load lock 220 may also be coupled to housing 208 and transfer chamber 210. Load lock 220 may be configured to interface with, and be coupled to, transfer chamber 210 on one side and factory interface 206. Load lock 220 may have an environmentally controlled atmosphere that may be changed from a vacuum environment (wherein substrates may be transferred to and from transfer chamber 210) to an inert-gas environment at or near atmospheric-pressure (wherein substrates may be transferred to and from factory interface 206) in some embodiments.

Factory interface 206 may be any suitable enclosure, such as, e.g., an Equipment Front End Module (EFEM). Factory interface 206 may be configured to receive substrates 202 from substrate carriers 222 (e.g., Front Opening Unified Pods (FOUPs)) docked at various load ports of factory interface 206. A factory interface robot 226 (shown dotted) may be configured to transfer substrates 202 between substrate carriers (also referred to as containers) 222 and load lock 220. In other and/or similar embodiments, factory interface 206 may be configured to receive replacement parts from replacement parts storage containers 222.

Manufacturing system 200 may also be connected to a client device (not shown) that is configured to provide information regarding manufacturing system 200 to a user (e.g., an operator). In some embodiments, the client device may provide information to a user of manufacturing system 200 via one or more graphical user interfaces (GUIs). For example, the client device may provide information regarding one or more modifications to be made to a process recipe for a substrate 202 via a GUI.

Manufacturing system 200 may also include a system controller 228. System controller 228 may be and/or include a computing device such as a personal computer, a server computer, a programmable logic controller (PLC), a microcontroller, and so on. System controller 228 may include one or more processing devices, which may be general-purpose processing devices such as a microprocessor, central processing unit, or the like. More particularly, the processing device may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device may also be one or more special-purpose processing devices such as an application specific integrated circuit (ASIC), a field programmable gate array (FPGA), a digital signal processor (DSP), network processor, or the like. System controller 228 may include a data storage device (e.g., one or more disk drives and/or solid state drives), a main memory, a static memory, a network interface, and/or other components. System controller 228 may execute instructions to perform any one or more of the methodologies and/or embodiments described herein. In some embodiments, system controller 228 may execute instructions to perform one or more operations at manufacturing system 200 in accordance with a process recipe. The instructions may be stored on a computer readable storage medium, which may include the main memory, static memory, secondary storage and/or processing device (during execution of the instructions).

System controller 228 may receive data from sensors included on or within various portions of manufacturing system 200 (e.g., processing chambers 214, 216, 218, transfer chamber 210, load lock 220, etc.). Data received by the system controller 228 may include spectral data and/or non-spectral data for a portion of substrate 202. For purposes of the present description, system controller 228 is described as receiving data from sensors included within processing chambers 214, 216, 218. However, system controller 228 may receive data from any portion of manufacturing system 200 and may use data received from the portion in accordance with embodiments described herein. In an illustrative example, system controller 228 may receive spectral data from one or more sensors for processing chamber 214, 216, 218 before, after, or during a substrate process at the processing chamber 214, 216, 218. Data received from sensors of the various portions of manufacturing system 200 may be stored in a data store 250. Data store 250 may be included as a component within system controller 228 or may be a separate component from system controller 228. In some embodiments, data store 250 may be data store 140 described with respect to FIG. 1.

Manufacturing system 200 may further include a substrate measurement system 240. Substrate measurement system 240 may obtain spectra measurements for one or more portions of a substrate 202 before, during, or after the substrate 202 is processed at manufacturing system 200. In some embodiments, substrate measurement system 240 may obtain spectral measurements for one or more portions of substrate 202 in response to receiving a request for the spectra measurements from system controller 228. Substrate measurement system 240 may be integrated within a portion of manufacturing system 200. In some embodiments, substrate measurement system 240 may be integrated with transfer chamber 210, as illustrated in FIG. 2. In other or similar embodiments, substrate measurement system 240 may be integrated within factory interface 206. In yet other or similar embodiments, substrate measurement system 240 may be integrated within one or more of processing chambers 214, 216, and/or 218. For example, one or more components of substrate measurement system 240 can be included within an interior environment of processing chambers 214, 216, and/or 218, In another example, a processing chamber 214, 216, 218 can include a window (e.g., in a lid of the processing chamber, in a side wall of the processing chamber, etc.) that optically exposes the interior environment of processing chamber 214, 216, 218 to an exterior environment of processing chamber 214, 216, 218. Substrate measurement system 240 can be disposed outside of processing chamber processing chamber 214, 216, 218 and configured to collect spectral data for a substrate while the substrate is within processing chamber 214, 216, 218. In yet other or similar embodiments, substrate measurement system 240 may not be integrated with any portion of manufacturing system 200 and instead may be a stand-alone component. In such embodiments, a substrate 202 measured at substrate measurement system 240 may be transferred to and from a portion of manufacturing system 200 prior to or after the substrate 202 is processed at manufacturing system 200.

Substrate measurement system 240 may obtain spectra measurements for a portion of substrate 202 by generating spectral data and/or non-spectral data for the portion of substrate 202. In some embodiments, substrate measurement system 240 is configured to generate spectral data, non-spectral data, positional data, and other substrate property data for substrate 202 (e.g., a thickness of substrate 202, a width of substrate 202, etc.). After generating data for substrate 202, substrate measurement system 240 may transmit the generated data to system controller 228. Responsive to receiving data from substrate measurement system 240, system controller 228 may store the data at data store 250. In other or similar embodiments, substrate measurement system 240 and/or system controller 228 can provide the data to spectral data engine 132. As described above, one or more portions of spectral data engine 132 can reside at system controller 228, in some embodiments.

FIG. 3 is a cross-sectional schematic side view of a substrate measurement system 300, according to aspects of the present disclosure. Substrate measurement system 300 can be the same as or can otherwise correspond to substrate measurement system 240 of FIG. 2. Substrate measurement system 300 may be configured to obtain measurements for one or more portions of a substrate, such as substrate 202 of FIG. 2, prior to, during, or after processing of substrate 202 at a processing chamber (e.g., processing chamber 214, 216, 218). Substrate measurement system 300 may obtain spectral measurements for a portion of substrate 202 by generating data (e.g., spectral data, non-spectral data, etc.) associated with the portion of substrate 202. In some embodiments, substrate measurement system 300 may be configured to generate spectral data, non-spectral data, positional data, and/or other property data associated with substrate 202. Substrate measurement system 300 may include a controller 330 configured to execute one or more instructions for generating data associated with a portion of substrate 202.

Substrate measurement system 300 may detect that substrate 202 has been transferred to substrate measurement system 300. Responsive to detecting that substrate 202 has been transferred to substrate measurement system 300, substrate measurement system 300 may determine a position and/or an orientation of substrate 202. The position and/or orientation of substrate 202 may be determined based on an identification of a reference location of substrate 202. A reference location may be a portion of substrate 202 that includes an identifying feature that is associated with a specific portion of substrate 202. Controller 228 may determine an identifying feature associated with a specific portion of substrate 202 based on determined identifying information for substrate 202.

Controller 330 may identify the reference location for substrate 202 using one or more camera components 350 configured to capture image data for substrate 202. Camera components 350 may generate image data for with one or more portions of the substrate 202 and transmit the image data to controller 330. Controller 330 may analyze the image data to identify an identifying feature associated with a reference location for substrate 202. Controller 330 may further determine a position and/or orientation of substrate 202 as depicted in the image data based on the identified identifying feature of substrate 202. Controller 330 may determine a position and/or orientation of substrate 202 based on the identified identifying feature of substrate 202 and the determined position and/or orientation of substrate 202 as depicted in the image data. Responsive to determining the position and/or orientation of substrate 202, controller 330 may generate positional data associated with one or more portions of substrate 202. In some embodiments, the positional data may include one or more coordinates (e.g., Cartesian coordinates, polar coordinates, etc.) each associated with a portion of substrate 202, where each coordinate is determined based on a distance from the reference location for substrate 202.

Substrate measurement system 300 may include one or more measurement components for measuring substrate 202. In some embodiments, substrate measurement system 300 may include one or more spectra sensing components 320 configured to generate spectral data for one or more portions of substrate 202. As discussed previously, spectral data may correspond to an intensity (i.e., a strength or amount of energy) of a detected wave of energy for each wavelength of the detected wave.

A spectra sensing component 320 may be configured to detect waves of energy reflected from a portion of substrate 202 and generate spectral data associated with the detected waves. Spectra sensing component 320 may include a wave generator 322 and a reflected wave receiver 324. In some embodiments, wave generator 322 may be a light wave generator configured to generate a beam of light towards a portion of substrate 202. In such embodiments, reflected wave receiver 324 may be configured to receive a reflected light beam from the portion of substrate 202. Wave generator 322 may be configured to generate an energy stream 326 (e.g., a light beam) and transmit energy stream 326 to a portion of substrate 202. A reflected energy wave 328 may be reflected from the portion of substrate 202 and received by reflected wave receiver 324.

Responsive to reflected wave receiver 324 receiving reflected energy wave 328 from the portion of substrate 202, spectra sensing component 320 may measure a wavelength of each wave included in reflected energy wave 328. Spectra sensing component 320 may further measure an intensity of each measured wavelength. Responsive to measuring each wavelength and each wavelength intensity, spectra sensing component 320 may generate spectral data for the portion of substrate 202. Spectra sensing component 320 may transmit the generated spectral data to controller 330. Controller 330 may, responsive to receiving the generated spectral data, generate a mapping between the received spectral data and positional data for the measured portion of substrate 202.

Substrate measurement system 300 may be configured to generate a specific type of spectral data based on a type of measurement to be obtained at substrate measurement system 300. In some embodiments, spectra sensing component 520 may be a first spectra sensing component that is configured to generate one type of spectral data. For example, spectra sensing component 320 may be configured to generate reflectometry spectral data, ellipsometry spectral data, hyperspectral imaging data, chemical imaging data, thermal spectral data, or conductive spectral data. In such embodiments, the first spectra sensing component may be removed from substrate measurement system 300 and replaced with a second spectra sensing component configured to generate a different type of spectral data (e.g., reflectometry spectral data, ellipsometry spectral data, hyperspectral imaging data, chemical imaging data, eddy current spectral data, thermal spectral data, or conductive spectral data).

In some embodiments, substrate measurement system 300 can include a substrate holder 340. Substrate holder 340 can be a chuck such as a vacuum chuck, an electrostatic chuck, a magnetic chuck, a mechanical chuck (e.g., a four jaw chuck, a three jaw chuck, an edge/ring clamp chuck, etc.) or other type of chuck. Substrate holder 340 may also be or include a plate or other surface with a substrate-shaped pocket and/or a set of pins or other features (e.g., three pins) that surround the substrate and keep the substrate from shifting relative to the substrate holder 340 during movement of the substrate holder 340. Substrate holder 340 may secure a substrate 202. In one embodiment, the substrate holder 340 includes an edge clamp that clamps the substrate from the edges. In one embodiment, substrate holder 340 is a vacuum chuck. In other embodiments, substrate holder 340 may be a different type of chuck such as an electrostatic chuck, a mechanical chuck, a magnetic chuck, or the like.

Substrate measurement system can include one or more positional components configured to modify a position and/or orientation of substrate 202 with respect to spectra sensing component 320. In some embodiments, the positional components can include a first actuator 352, which can move substrate holder 340 about a first axis (e.g., a rotational axis) and/or a second axis (e.g., a vertical axis). In some embodiments, first actuator 352 can be controlled by a servo controller and/or a servomotor, which may allow for precise control of a rotational position, linear position, velocity, and/or acceleration of first actuator 352 and thus substrate holder 340. Substrate holder 340 may have a mass between 1.0 kilograms (kg) and 2.0 kg, which allows for linear and/or rotational accelerations between 6000 deg/sec² and 14000 deg/sec². In additional or alternative embodiments, the positional components can include a second actuator 354, which can move substrate holder 340 along a second axis (e.g., a horizontal axis). Second actuator 354 can be controlled by a servo controller and/or a servomotor, in some embodiments, which may allow for precise control of a linear position, velocity, and/or acceleration of second actuator 354, and thus of substrate holder 340.

As spectra sensing component 320 generates spectral data for one or more portions of substrate 202, the one or more positional components may modify the position and/or orientation of substrate 202 in accordance with the one or more determined portions to be measured for substrate 202. For example, prior to spectra sensing component 320 generating spectral data for substrate 202, the positional component(s) may position substrate 202 at Cartesian coordinate (0,0) and spectra sensing component 320 may generate first spectral data for substrate 202 at Cartesian coordinate (0,0). Responsive to spectra sensing component 320 generating first spectral data for substrate 202 at Cartesian coordinate (0,0), second actuator 354 may translate substrate 202 along the horizontal axis so that spectra sensing component 320 is configured to generate second spectral data for substrate 202 at Cartesian coordinate (0,1). Responsive to spectra sensing component 320 generating second spectral data for substrate 202 at Cartesian coordinate (0,1), the first actuator 352 may rotate substrate 202 along the first axis so that spectra sensing component 320 is configured to generate third spectral data for substrate 202 at Cartesian coordinate (1,1). This process may occur multiple times until spectral data is generated for each determined portion of substrate 202.

In some embodiments, one or more layers 312 of material may be included on a surface of substrate 202. The one or more layers 312 may include photoresist material, mask material, deposited material, etc. In some embodiments, the one or more layers 312 may include a layer of material to be etched according to an etch processed performed at a processing chamber. In such embodiments, spectral data may be collected for one or more portions of the un-etched material of the one or more layers 312 deposited on substrate 202, in accordance with previously disclosed embodiments. In other or similar embodiments, the one or more layers 312 may include a layer of a material that has already been etched according an etch process at the processing chamber. In such embodiments, one or more structural features (e.g., lines, columns, openings, etc.) may be etched into the one or more layers 312 of substrate 202. In such embodiments, spectral data may be collected for one or more structural features etched into the one or more layers 312 of substrate 202.

Responsive to receiving at least one of the spectral data, the positional data, or the property data for the substrate 202, controller 330 may transmit the received data to system controller 228 for processing and analysis, in accordance with embodiment described herein.

As indicated above, one or more components of substrate measurement system 300 can be included in a processing chamber 214, 216, 218 and/or otherwise configured to collect spectral data for a substrate within the processing chamber 214, 216, 218. In one illustrative example, a processing chamber (e.g., processing chamber 214) can include a substrate support assembly that is configured to support a substrate 202 during a process (e.g., a substrate process, etc.). Camera components 350 and/or spectra sensing component 320 can be included within the processing chamber 214 and can generate spectral data and/or non-spectral data for substrate 202 before, during or after the process, as described herein. Camera component 350 and/or spectra sensing component 320 can transmit the generated measurements to controller 330, which may be located outside of the processing chamber. Controller 330 can transmit the generated measurements to system controller 228 and/or to spectral data engine 132, as described herein. In another illustrative example, a transparent window can be embedded within one or more surfaces of processing chamber 214 (e.g., a lid, an exterior wall, etc.). Camera component 350 and/or spectra sensing component 320 can be configured to generate spectra data by detecting spectra from outside of the processing chamber 214 through the transparent window, in some embodiments. It should be noted that camera component 350, spectra sensing component 320 and/or any other component of substrate measurement system 300 can be configured to generate spectral data and/or non-spectral data for a substrate 202 within or outside of a processing chamber 214, 216, 218 according to any orientation, according to embodiments described herein.

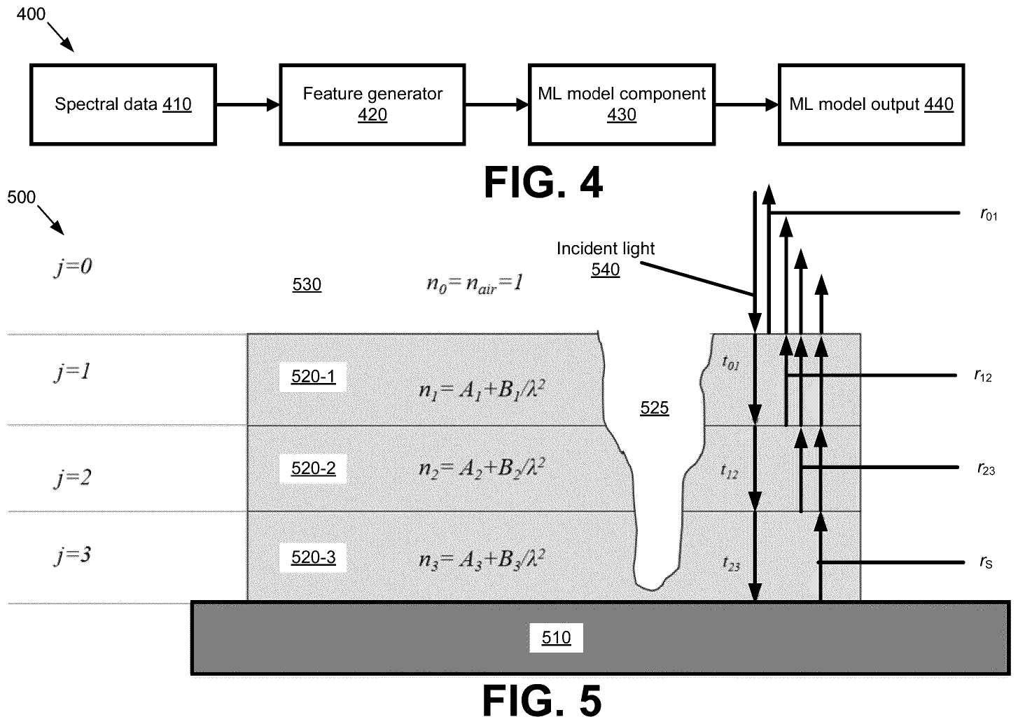

FIG. 4 is a block diagram of an example system 400 for implementing features generated using DEMRA of patterned substrates, according to some embodiments of the present disclosure. As shown, spectral data 410 associated with a patterned substrate is received by feature generator 420. In some embodiments, feature generator 420 is included in spectral data engine 172 of FIG. 1. Spectral data 410 can include data corresponding to at least one optical spectra measurement of the patterned substate. For example, spectral data 410 can include data defining a relationship between reflectance and a wavelength of light incident on the patterned substrate (e.g., vacuum wavelength). Feature generator 420 can generate a set of features from spectral data 410 using DEMRA. More specifically, the set of features can include a set of fitting parameters of an empirical model that relates the effective index of refraction n to the wavelength of incident light λ and uses at least one fitting parameter. Examples of empirical models include the Cauchy dispersion model, the Lorentz model, the Tauc-Lorentz model, the Forouhi-Bloomer model, the Drude model, or any other suitable empirical model.

The set of fitting parameters can be unique to the material of the patterned substrate. Each fitting parameter of a set of fitting parameters is a respective constant value. The set of fitting parameters can be used as proxy for physical variation in the effective index of refraction through the patterned substrate. The set of fitting parameters can be determined using DEMRA of the patterned substrate. An illustrative example of using feature generator 420 to generate features using DEMRA of a patterned substrate will now be described below with reference to FIG. 5.

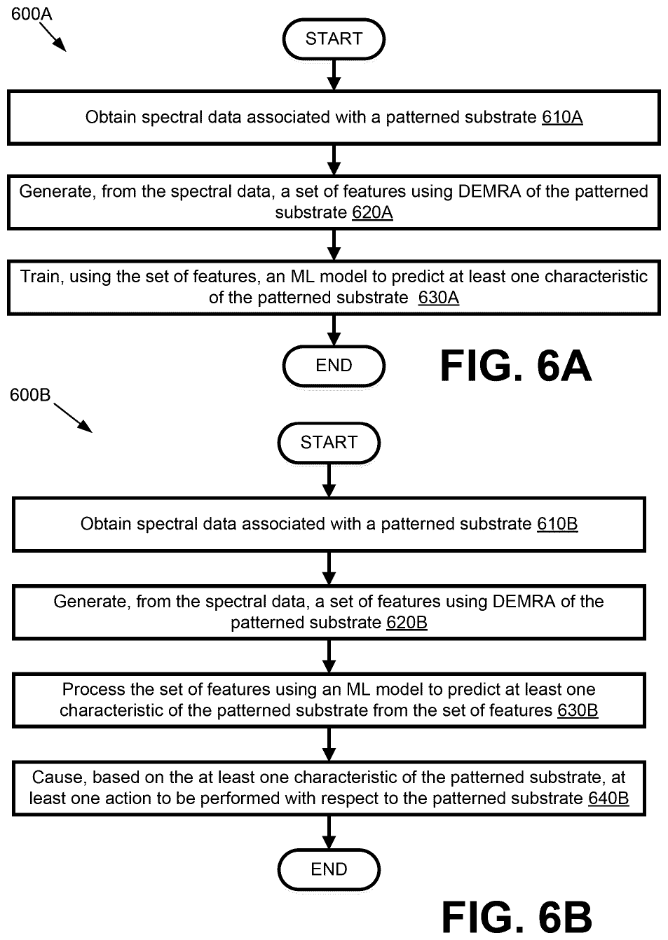

ML model component 430 can use the set of features (e.g., the set of fitting parameters of the empirical model) to cause an ML model to generate ML model output 440. More specifically, ML model output 440 can include at least one characteristic of the patterned substrate predicted by the ML model from the set of features. Illustratively, a characteristic of a patterned substrate can be a CD, such as a trench width at one or more depths. In some embodiments, ML model component 430 uses the set of features to train a machine model to predict (e.g., estimate) the at least one characteristic of the patterned substrate. In some embodiments, ML model component 430 uses a machine learning model trained to predict (e.g., estimate) the at least one characteristic of the patterned substrate from the set of features. Further details regarding ML model component 430 using the set of features to cause an ML model to generate ML mode output 440 will be described below with reference to FIGS. 6A-6B.

FIG. 5 is a diagram 500 of an example of using DEMRA to generate a set of features of a patterned substrate, according to some embodiments. Diagram 500 shows a substrate (e.g., silicon (Si) substrate) 510, a patterned substrate modeled into layers 520-1 through 520-3, and atmosphere (or vacuum) 530. Generally, the patterned substrate can have N layers of thicknesses t₁ through t_{N} and effective indices of refraction n₁ through n_{N}. Each layer of the patterned substrate is denoted by variable j, where layer 520-1 corresponds to j=1, layer 520-2 corresponds to j=2, layer 530-3 corresponds to j=3, and atmosphere 530 corresponds to j=0 by convention. Although three layers modeling a patterned substrate are shown in FIG. 5, the number of layers used to model the patterned substrate should not be considered limiting. Void (e.g., trench) 525 is formed through layers 520-1 through 520-3. Void 525 can represent a pattern (e.g., an etched pattern) within the layers of the patterned substrate. Incident light 540 hits layer 520-1 and transmits through the layers 520-1 through 520-3 of the patterned substrate.

Boundary conditions for a scenario of incident light 540 generally refer to the known indices of refraction at the “boundaries” or a region of interest (surfaces of the patterned substrate). For example, boundary conditions can include the known refractive index of air (e.g., n₀=1), the known refractive index and/or reflectance spectra of the base (n₁), etc. The set of features can include a set of fitting parameters of an empirical model that relates each index of refraction to the wavelength of incident light 540 and uses at least one fitting parameter. Examples of empirical models include the Cauchy dispersion model, the Lorentz model, the Tauc-Lorentz model, the Fourhi-Bloomer model, the Drude model, or any suitable empirical model. The set of fitting parameters can be unique to the material of the patterned substrate. Each fitting parameter of a set of fitting parameters is a respective constant value. The set of fitting parameters can be used as proxy for physical variation in the effective index of refraction through the patterned substrate. The set of fitting parameters may be solved for a patterned substrate based on received spectral data. Thus, the set of fitting parameters can be used as a set of features for training an ML model used to predict (e.g., estimate) at least one characteristic of the patterned substrate, or using an ML model trained to predict (e.g., estimate) the at least one characteristic of the patterned substrate, rather than using the raw spectral data to train the ML model or as an input to the trained ML model. Illustratively, a characteristic of a patterned substrate can be a CD.

The set of fitting parameters of the set of features can be derived in part using the Fresnel equation. The Fresnel equation defines a relationship between the total reflection R and the total transmission T through a stack of materials, given the effective index of refraction and the thickness of each layer in the stack. More specifically, the Fresnel equation can relate R and T as follows:

$$( \begin{matrix}1 \\ R\end{matrix} ) = \overline{M} ( \begin{matrix}T \\ 0\end{matrix} ) \qquad ( 1 )$$

$$\overline{M} = \frac{1}{{t}_{0 , 1}} ( \begin{matrix}1 & {r}_{0 , 1} \\ {r}_{0 , 1} & 1\end{matrix} ) {M}_{1} {M}_{2} … {M}_{N - 2} \qquad ( 2 )$$

$${M}_{j} = ( \begin{matrix}{e}^{- i {δ}_{j}} & 0 \\ 0 & {e}^{i {δ}_{j}}\end{matrix} ) ( \begin{matrix}1 & {r}_{j , j + 1} \\ {r}_{j , j + 1} & 1\end{matrix} ) \frac{1}{{t}_{j , j + 1}} \qquad ( 3 )$$

where r_{j,j+1} and t_{j,j+1} are the coefficients of refraction and transmission, respectively, at the boundary between the j-th and the (j+1)th layer of the stack. These may be specified by the indices of refraction nⱼ and nⱼ₊₁ of the j-th and the (j+1)th layer of the stack, respectively:

$${r}_{j , j + 1} = \frac{{n}_{j} - {n}_{j + 1}}{{n}_{j} + {n}_{j + 1}} \qquad ( 4 )$$

$${t}_{j , j + 1} = \frac{2 {n}_{j + 1}}{{n}_{j} + {n}_{j + 1}} \qquad ( 5 )$$

where λ is the wavelength of incident light 540. Moreover, δⱼ is the phase shift due to the jth layer:

$${δ}_{j} = \frac{2 π {n}_{j} Δ {z}_{j}}{λ} \{ \begin{matrix}1 & {n}_{j + 1} > {n}_{j} \\ - 1 & {n}_{j + 1} < {n}_{j}\end{matrix} \qquad ( 6 )$$

### Let

$$\overline{M} = ( \begin{matrix}{m}_{0 , 0} & {m}_{0 , 1} \\ {m}_{1 , 0} & {m}_{1 , 1}\end{matrix} ) \to R = \frac{{m}_{1 , 0}}{{m}_{0 , 0}} \qquad ( 7 )$$

Thus, given a set of values for each nⱼ, the total reflectance R can be computed.

Spectral data can relate R to the wavelength of incident light 540, λ. Thus, for a single layer j (e.g., layer 520-1, layer 520-2 or layer 520-3) with index of refraction nⱼ, the effective index of refraction nⱼ can be defined as:

$${n}_{j} = f ( λ , {A}_{1 j} , … {A}_{K j} ) \qquad ( 8 )$$

where ƒ(⋅) is a function of A corresponding to an empirical model with K fitting parameters A₁ⱼ through A_{Kj}. For instance, if the empirical model is the Cauchy dispersion model, K=2 and

$${n}_{j} = f ( λ , {A}_{1 j} , … {A}_{K j} ) = A + \frac{B}{{λ}^{2}} ,$$

where A=A₀ⱼ and B=A₁ⱼ.

Using the empirical model (e.g., the Cauchy dispersion model), each index of refraction term n; can be substituted in equation (8) for R with expressions in terms of wavelength. This can be used to determine an equation for R in terms of wavelength and a set of parameters for the empirical model. More specifically, each nⱼ can be substituted for R with the corresponding expressions ƒ(λ, A₁ⱼ, . . . . A_{Kj}) where j=0, . . . , N. For example, a set of fitting parameters [symbol] for the empirical model can be defined as:

$$𝒜 = \{ {A}_{j k} \vert 0 < j < N , 0 < k < K \} \qquad ( 9 )$$

Given the set of fitting parameters [symbol] and the function ƒ(⋅) defining the empirical model, an expression for R in terms of λ can be obtained. Since the spectrum at a particular measurement point is a large set of (R, λ) pairs such that |(R, λ)|>| [symbol] |=NK, the values of the fitting parameters of [symbol] can be numerically solved for (“fitted”) for particular optical spectra data for a particular measurement. Thus, the particular optical spectra data can be mapped to the set of fitting parameters [symbol] , where the set of fitting parameters [symbol] for the particular optical spectra data can form at least a portion of a set of features, which may be input into an ML model to determine an estimate of one or more properties (e.g., critical dimensions) of the patterned substrate. Accordingly, the set of parameters [symbol] , operating as a proxy for physical variation of the effective index of refraction of the patterned substrate represented by layers 520-1 through 520-3, can be used to generate the set of features for training an ML model used to predict (e.g., estimate) at least one characteristic of the patterned substrate, or for input into an ML model trained to predict (e.g., estimate) the at least one characteristic of the patterned substrate.

To fully solve the equations, consider the boundary conditions at the top and the bottom of the patterned substrate, and in particular the atmosphere and the base. As mentioned above, the atmosphere is the 0^{th} layer having an effective index of refraction of 1 (n₀=1). Thus, according to equations (4) and (5), the coefficients of refraction and transmission, respectively, at the atmosphere-substrate boundary are:

$${r}_{0 , 1} = \frac{1 - {n}_{1}}{1 + {n}_{1}} \qquad ( 10 )$$

$${t}_{0 , 1} = \frac{2 {n}_{1}}{1 + {n}_{1}} \qquad ( 11 )$$

For the (N−1)th layer, instead of substituting the effective index of refraction n_{N-1}, we can use the known reflectance of the material of the substrate 510 (e.g., Si) and plug in those values for the r_{N-1,N} term. It can be assumed that the remaining transmission is completely absorbed, and thus a T_{N-1,N} term is not needed. In some embodiments, the patterned substrate includes layers 520-1 through 520-3 having approximately equal thickness (N=3) as shown in FIG. 5. In some embodiments, the layers 520-1 through 520-3 have varied thicknesses. Using the Cauchy dispersion model, the set of fitting parameters is [symbol] ={A₁, B₁, A₂, B₂, A₃, B₃}. From equations (2)-(3), M̅ is equal to the product:

$$\overline{M} = \frac{1}{{t}_{0 , 1} {t}_{1 , 2} {t}_{2 , 3}} ( \begin{matrix}1 & {r}_{0 , 1} \\ {r}_{0 , 1} & 1\end{matrix} ) ( \begin{matrix}{e}^{- i {δ}_{1}} & 0 \\ 0 & {e}^{i {δ}_{1}}\end{matrix} ) ( \begin{matrix}1 & {r}_{1 , 2} \\ {r}_{1 , 2} & 1\end{matrix} ) ( \begin{matrix}{e}^{- i {δ}_{2}} & 0 \\ 0 & {e}^{i {δ}_{2}}\end{matrix} ) ( \begin{matrix}1 & {r}_{2 , 3} \\ {r}_{2 , 3} & 1\end{matrix} ) ( \begin{matrix}{e}^{- i {δ}_{3}} & 0 \\ 0 & {e}^{i {δ}_{3}}\end{matrix} ) ( \begin{matrix}1 & {r}_{s} \\ {r}_{s} & 1\end{matrix} ) \qquad ( 12 )$$

where rₛ is the coefficient of refraction of the substrate 510 (e.g., Si). Using equations (4)-(6) and the Cauchy dispersion model, the values for r, t and δ in equation (12) can be determined as follows:

$${r}_{0 , 1} = \frac{1 - ( {A}_{1} + {B}_{1} / {λ}^{2} )}{1 + ( {A}_{1} + {B}_{1} / {λ}^{2} )} \qquad ( 13 )$$

$${t}_{0 , 1} = \frac{2 ( {A}_{1} + {B}_{1} / {λ}^{2} )}{1 + ( {A}_{1} + {B}_{1} / {λ}^{2} )} \qquad ( 14 )$$

$${r}_{1 , 2} = \frac{( {A}_{1} - {A}_{2} ) + ( {B}_{1} - {B}_{2} / {λ}^{2} )}{( {A}_{1} + {A}_{2} + ( {B}_{1} + {B}_{2} ) / {λ}^{2} )} \qquad ( 15 )$$

$${t}_{1 , 2} = \frac{2 ( {A}_{2} + {B}_{2} / {λ}^{2} )}{( {A}_{1} + {A}_{2} + ( {B}_{1} + {B}_{2} ) / {λ}^{2} )} \qquad ( 16 )$$

$${r}_{2 , 3} = \frac{( {A}_{2} - {A}_{3} ) + ( {B}_{2} - {B}_{3} / {λ}^{2} )}{( {A}_{2} + {A}_{3} + ( {B}_{2} + {B}_{3} ) / {λ}^{2} )} \qquad ( 17 )$$

$${t}_{2 , 3} = \frac{2 ( {A}_{3} + {B}_{3} / {λ}^{2} )}{( {A}_{2} + {A}_{3} + ( {B}_{2} + {B}_{3} ) / {λ}^{2} )} \qquad ( 18 )$$

$${δ}_{j} = \frac{2 π ( {A}_{j} + {B}_{j} / {λ}^{2} ) Δ {z}_{j}}{λ} \{ \begin{matrix}1 & ( {A}_{j + 1} + {B}_{j + 1} / {λ}^{2} ) > ( {A}_{j} + {B}_{j} / {λ}^{2} ) \\ - 1 & ( {A}_{j + 1} + {B}_{j + 1} / {λ}^{2} ) < ( {A}_{j} + {B}_{j} / {λ}^{2} )\end{matrix} \qquad ( 19 )$$

where Δzⱼ refers to the thickness of layer j.

As shown above, equation (12) that is used to solve for M̅ can be expanded in terms of λ and the set of fitting parameters {A, B} per equations (13)-(19). Moreover, R is fully defined in terms of the elements of M̅ (e.g., equation (7)). This expansion can be done programmatically. Therefore, an expression for R in terms of λ and the set of fitting parameters {A, B} can be obtained. Accordingly, values of (R, λ) from spectral data can then be used to determine the value of each parameter of the set of fitting parameters {A, B}.

As described above, the set of fitting parameters can then be used to train an ML model to predict (e.g., estimate) at least one characteristic of the patterned substrate. Further details regarding training the ML model will be described below with reference to FIG. 6A. Alternatively, as described above, the set of fitting parameters can be input into a trained ML model used to predict (e.g., estimate) the at least one characteristic of the patterned substrate. Further details regarding using the trained ML model will be described below with reference to FIG. 6B.

FIG. 6A is a flow chart of an example method 600A for training an ML model using features generated using DEMRA of patterned substrates, according to aspects of the present disclosure. Method 600A can be performed by processing logic that can include hardware (circuitry, dedicated logic, etc.), software (such as is run on a general-purpose computer system or a dedicated machine), firmware, or some combination thereof. In some embodiments, method 600A can be performed by a one or more components of a system, such as one or more of the systems described above with reference to FIGS. 1-4. In some embodiments, one or more operations of method 600A can be performed by one or more other machines not depicted in the figures.

At block 610A, processing logic obtains spectral data associated with a patterned substrate. More specifically, the spectral data can be obtained by a substrate measurement system performing one or more spectral measurements of one or more regions of the patterned substrate. The patterned substrate can be located within a manufacturing system. The patterned substrate may have been processed by one or more processing chambers according to one or more operations of one or more process recipes. The spectral data can define a relationship between reflectance and the wavelength of light incident on the patterned substrate (e.g., vacuum wavelength of light). In some embodiments, the spectral data is indicative of a state of the patterned substrate after completion of the one or more operations and/or prior to completion of all operations of the one or more process recipes.

In some embodiments, a system controller (e.g., system controller 228 of FIG. 2) can determine that the process recipe and/or the one or more first operations performed for the patterned substrate (e.g., substrate 202 of FIG. 2) are unknown to the system controller (e.g., by determining that there is no data or information indicating an association of the process recipe the substrate in memory). The system controller can cause a substrate measurement system (e.g., substrate measurement system 300 of FIG. 3) to generate spectral data for one or more regions of the patterned substrate. The substrate measurement system can be included at or otherwise connected to a transfer chamber (e.g., transfer chamber 210). In such embodiments, the system controller can transmit a signal to a motion controller to cause a transfer chamber robot to transfer the patterned substrate from a processing chamber to the substrate measurement system. In some embodiments, the substrate measurement system can be included in or otherwise connected to a factory interface (e.g., factory interface 206 of FIG. 2 outside of a vacuum environment). In such embodiments, the system controller can transmit a first signal to a motion controller to cause the transfer chamber robot to transfer the patterned substrate from a processing chamber to a load lock (e.g., load lock 220 of FIG. 2) and a second signal to a motion controller to cause a factory interface robot (e.g., factory interface robot 226 of FIG. 2) to transfer the patterned substrate from a load lock to the substrate measurement system. In some embodiments, one or more components of the substrate measurement system are included at or otherwise configured to collect spectral data and/or non-spectral data for the patterned substrate while the patterned substrate is in a processing chamber. In such embodiments, the patterned substrate can remain in the processing chamber for measurement.

In some embodiments, the system controller can transmit a signal to a controller of the substrate measurement system (e.g., controller 330 of FIG. 3) to cause the substrate measurement system to perform one or more measurements to generate spectral data for one or more regions of the patterned substrate. In some embodiments, the signal can include an indication of the one or more regions of the patterned substrate. In other or similar embodiments, the one or more regions of the patterned substrate can be provided to the controller of the substrate measurement system prior to initialization of a process tool and/or a processing chamber of the process tool. In some embodiments, the controller of the substrate measurement system can cause one or more positional components to move (e.g., rotate, translate) the patterned substrate along one or more axes to a target position. In some embodiments, spectra sensing component(s) and/or camera components of the substrate measurement system (e.g., spectra sensing component(s) 320 and/or camera component(s) 350 of FIG. 3) can collect spectral data and/or non-spectral data for the patterned substrate after the patterned substrate is moved to the target position. The collected spectral data and non-spectra data for the patterned substrate can then be stored. In some embodiments, the collected spectral data includes a surface profile or map that includes spectral measurements for many locations on the substrate.

At operation 620A, processing logic generates, from the spectral data, a set of features using DEMRA of the patterned substrate. More specifically, the set of features can include a set of fitting parameters of an empirical model that relates the effective index of refraction n to the wavelength of incident light 1. Examples of empirical models include the Cauchy dispersion model, the Lorentz model, the Tauc-Lorentz model, the Forouhi-Bloomer model, the Drude model, etc. The set of fitting parameters can be unique to the material of the patterned substrate. Each fitting parameter of a set of fitting parameters is a respective constant value for a single measurement region. The set of fitting parameters can be used as proxy for physical variation in the effective index of refraction through the patterned substrate.

At operation 630A, processing logic trains, using the set of features, an ML model to predict at least one characteristic of the patterned substrate. For example, predicting the at least one characteristic can include estimating the at least one characteristic. In some embodiments, the at least one characteristic of the patterned substrate includes a CD. For example, the ML model can correspond to ML model 190 of FIG. 1. Training the ML model can include initializing a training set to empty (e.g., { }). Training the ML model can further include generating an association (e.g., mapping) between the set of features and a characteristic of the patterned substrate.

In some embodiments, the ML model is a neural network. Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

To effectuate training, processing logic inputs a training dataset(s) into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the sets of features generated from spectral data into the machine learning model one at a time. Each input may include features for spectral data from an imaged substrate. The machine learning model processes the input to generate an output. An artificial neural network includes an input layer that consists of values in a data point (e.g., intensity values and/or height values of pixels in a height map). The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction, estimation and/or output that the machine learning model can produce.

Processing logic may then compare the generated output (e.g., CD values) to the known CD values for the substrate associated with the input training data. Processing logic determines an error (i.e., a classification error) based on the differences between the output values and the values. Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed input data from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criteria is met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

Training the ML model can further include adding the association to the training set. Training the ML can further include determining whether the training set is sufficient for training. If not, then training the ML model can further include generating a new set of features from spectral data, and train the ML model using the new set of features. If the training set is sufficient for training, training the ML model can include using the training set to train the ML model. Further details regarding operations 610A-630A are described above with reference to FIGS. 1-5.

FIG. 6B is a flow chart of an example method 600B for implementing features generated using DEMRA of patterned substrates, according to aspects of the present disclosure, according to aspects of the present disclosure. Method 600B can be performed by processing logic that can include hardware (circuitry, dedicated logic, etc.), software (such as is run on a general-purpose computer system or a dedicated machine), firmware, or some combination thereof. In some embodiments, method 600B can be performed by a one or more components of a system, such as one or more of the systems described above with reference to FIGS. 1-4. In some embodiments, one or more operations of method 600B can be performed by one or more other machines not depicted in the figures.

At operation 610B, processing logic obtains spectral data associated with a patterned substrate. Operation 610B can be similar to operation 610A of FIG. 6A.

At operation 620B, processing logic generates, from the spectral data, a set of features using DEMRA of the patterned substrate. Operation 620B can be similar to operation 610B of FIG. 6B.

At operation 630B, processing logic processes the set of features using an ML model to predict at least one characteristic of the patterned substrate from the set of features. For example, processing the set of features using the ML model can include using a ML model trained to predict (e.g., estimate) at least one characteristic of the patterned substrate from the set of features. In some embodiments, the at least one characteristic of the patterned substrate includes a CD. For example, the ML model can be trained as described above with reference to FIG. 6A.

At operation 640B, processing logic causes, based on the at least one characteristic of the patterned substrate, at least one action to be performed with respect to the patterned substrate. In some embodiments, causing the at least one action to be performed with respect to the patterned substrate includes modifying at least one process recipe used to pattern a substrate, and causing a substrate to be patterned using the at least one modified process recipe. More specifically, one or more parameters of a process recipe can be modified to optimize substrate patterning. In some embodiments, causing the at least one action to be performed with respect to the patterned substrate includes determining that a processing chamber is defective, and causing maintenance to be performed on the processing chamber in response to determining that the processing chamber is defective. More specifically, the at least one characteristic of the patterned substrate can be indicative of a processing chamber defect, and thus the processing chamber can be repaired to remove the processing chamber defect. In some embodiments, an action is no action (e.g., no adjustment to the system). For example, the predictions can show that the patterned substrate is of acceptable quality.

For simplicity of explanation, methods 600A and 600B are depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

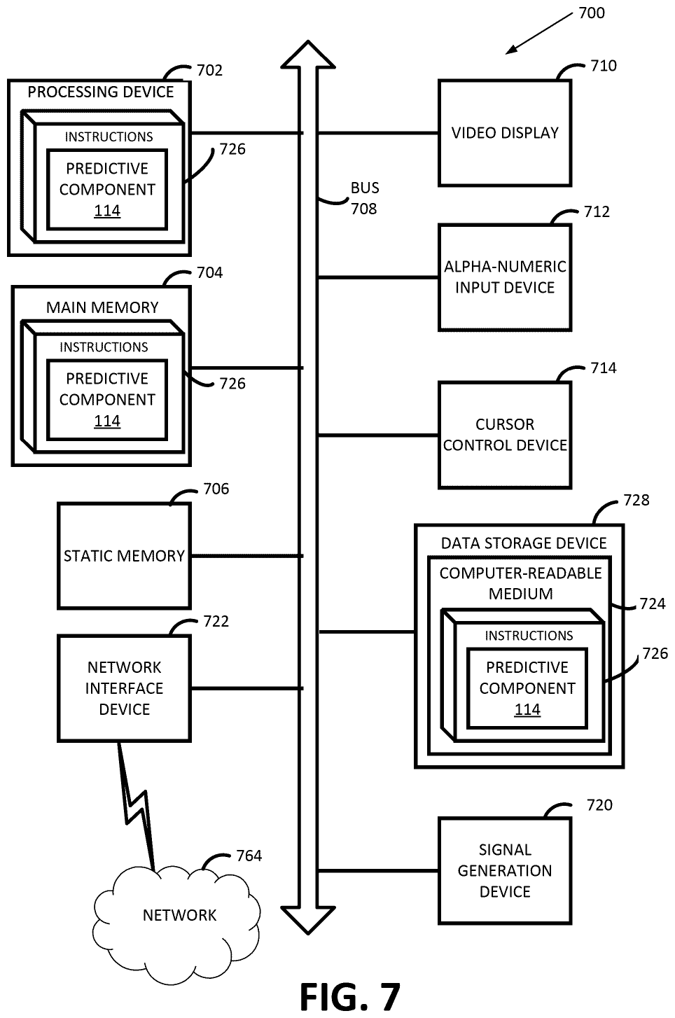

FIG. 7 depicts a block diagram of an illustrative computer system 700 operating in accordance with one or more aspects of the present disclosure. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein. In embodiments, computing device 700 may correspond to predictive component 114 and/or spectral data engine 132 of FIG. 1, system controller 228 of FIG. 2 or controller 330 of FIG. 3.

The example computing device 700 includes a processing device 702, a main memory 704 (e.g., read-only memory (ROM), flash memory, dynamic random access memory (DRAM) such as synchronous DRAM (SDRAM), etc.), a static memory 706 (e.g., flash memory, static random access memory (SRAM), etc.), and a secondary memory (e.g., a data storage device 728), which communicate with each other via a bus 708.

Processing device 702 may represent one or more general-purpose processors such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. Processing device 702 may also be or include a system on a chip (SoC), programmable logic controller (PLC), or other type of processing device. Processing device 702 is configured to execute the processing logic for performing operations and steps discussed herein.

The computing device 700 may further include a network interface device 1022 for communicating with a network 764. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 720 (e.g., a speaker).

The data storage device 728 may include a machine-readable storage medium (or more specifically a non-transitory computer-readable storage medium) 724 on which is stored one or more sets of instructions 726 embodying any one or more of the methodologies or functions described herein. Wherein a non-transitory storage medium refers to a storage medium other than a carrier wave. The instructions 726 may also reside, completely or at least partially, within the main memory 704 and/or within the processing device 702 during execution thereof by the computer device 700, the main memory 704 and the processing device 702 also constituting computer-readable storage media.

The computer-readable storage medium 724 may also be used to store an ML model (e.g., ML model 190 of FIG. 1) and data used to train the ML model. The computer readable storage medium 724 may also store a software library containing methods that call the ML model. While the computer-readable storage medium 724 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
obtaining, by at least one processing device, spectral data associated with a patterned substrate;
generating, by the at least one processing device from the spectral data, a set of features using discrete effective medium refractive analysis (DEMRA) of the patterned substrate, wherein the set of features comprises a set of fitted parameters corresponding to an empirical model that relates at least one effective index of refraction associated with the patterned substrate to a wavelength of light incident on the patterned substrate; and
processing, by the at least one processing device, the set of features using a machine learning model to predict at least one characteristic of the patterned substrate from the set of features.

2. The method of claim 1, wherein the at least one characteristic of the patterned substrate comprises a critical dimension of the patterned substrate.

3. The method of claim 1, wherein the spectral data defines a relationship between reflectance and the wavelength of light incident on the patterned substrate.

4. The method of claim 1, wherein the empirical model is one of: a Cauchy dispersion model, a Lorentz model, a Tauc-Lorentz model, a Fourhi-Bloomer model, or a Drude model.

5. The method of claim 1, further comprising:
obtaining, by the at least one processing device, a second set of features generated using DEMRA of a second patterned substrate based on second spectral data associated with the second patterned substrate; and
training, by the processing device using the second set of features, the machine learning model to predict at least one characteristic of the second patterned substrate.

6. The method of claim 1, further comprising causing, by the processing device based on the at least one characteristic of the patterned substrate, at least one action to be performed with respect to the patterned substrate.

7. The method of claim 6, wherein causing the at least one action to be performed with respect to the patterned substrate comprises at least one of:
causing a substrate to be patterned using at least one modified process recipe; or
causing maintenance to be performed on a processing chamber.

8. A system comprising:
a memory; and
at least one processing device, operatively coupled to the memory, to:
obtain spectral data associated with a patterned substrate;
generate, from the spectral data, a set of features using discrete effective medium refractive analysis (DEMRA) of the patterned substrate, wherein the set of features comprises a set of fitted parameters corresponding to an empirical model that relates at least one effective index of refraction associated with the patterned substrate to a wavelength of light incident on the patterned substrate; and
process the set of features using a machine learning model to predict at least one characteristic of the patterned substrate from the set of features.

9. The system of claim 8, wherein the at least one characteristic of the patterned substrate comprises a critical dimension of the patterned substrate.

10. The system of claim 8, wherein the spectral data defines a relationship between reflectance and the wavelength of light incident on the patterned substrate.

11. The system of claim 8, wherein the empirical model is one of: a Cauchy dispersion model, a Lorentz model, a Tauc-Lorentz model, a Fourhi-Bloomer model, or a Drude model.

12. The system of claim 8, wherein the at least one processing device is further to:
obtain a second set of features generated using DEMRA of a second patterned substrate based on second spectral data associated with the second patterned substrate; and
train, using the second set of features, the machine learning model to predict at least one characteristic of the second patterned substrate.

13. The system of claim 8, wherein the at least one processing device is further to cause, based on the at least one characteristic of the patterned substrate, at least one action to be performed with respect to the patterned substrate.

14. The system of claim 13, wherein, to cause the at least one action to be performed with respect to the patterned substrate, the at least one processing device is to at least one of:
cause a substrate to be patterned using at least one modified process recipe; or
cause maintenance to be performed on a processing chamber.

15. A system comprising:
a memory; and
at least one processing device, operatively coupled to the memory, to:
obtain a set of features generated using discrete effective medium refractive analysis (DEMRA) of a patterned substrate based on spectral data associated with a second patterned substrate, wherein the set of features comprises a set of fitted parameters corresponding to an empirical model that relates at least one effective index of refraction associated with the patterned substrate to a wavelength of light incident on the patterned substrate; and
train, using the set of features, a machine learning model to predict at least one characteristic of the patterned substrate.

16. The system of claim 15, wherein the at least one characteristic of the patterned substrate comprises a critical dimension of the patterned substrate.

17. The system of claim 15, wherein the spectral data defines a relationship between reflectance and the wavelength of light incident on the patterned substrate.

18. The system of claim 15, wherein the empirical model is one of: a Cauchy dispersion model, a Lorentz model, a Tauc-Lorentz model, a Fourhi-Bloomer model, or a Drude model.

19. The system of claim 8, wherein the at least one processing device is further to:
obtain a second set of features generated using DEMRA of a second patterned substrate based on second spectral data associated with the second patterned substrate; and
process the second set of features using the machine learning model to predict at least one characteristic of the second patterned substrate from the second set of features.

20. The system of claim 19, wherein the at least one processing device is further to cause, based on the at least one characteristic of the second patterned substrate, at least one action to be performed with respect to the second patterned substrate.
